(19) United States
(12) Patent Application Publication
(10) Pub. No.: US 2005/0040970 A1
(43) Pub. Date: Feb. 24, 2005

(54) Informational system using lighted message arrays for providing direction and guidance traffic ways

(76) Inventors: J. Marc Hutchins, Ontario (CA); Nicholas D. Hutchins, Ontario (CA)

Correspondence Address: Charles C Valauskas;Baniak Pine & Gannon, Suite 1200, 150 North Wacker Drive, Chicago, IL, 60606-1606, US

(21) Appl. No.: 10/493,118

(22) PCT Filed: Oct. 18, 2002
(86) PCT No.: PCT/IB02/04699

(30) Foreign Application Priority Data
Oct. 19, 2001 (US) 60344689
Oct. 19, 2001 (US) 60344748
Apr. 3, 2002 (US) 10089823

(51) Int. Cl. G08G 1/095

(52) U.S. Cl. 340/907; 340/905

(57) ABSTRACT

A system for providing information to traffic ways, such as roadways, runways and walkways. The system includes one or more lamp modules arranged into a message array, which may be embedded into the traffic way so as to provide enhanced viewing by a traveller, driver or the like. The message array may be controlled by signals generated by a central processing unit. Sensors, which may be remote from and/or positioned within the lamp modules sense various environmental conditions. The sensed conditions may be used by the central processing unit to generate predetermined signals in response to the sensed condition.

### FIELD OF THE INVENTION

The present invention is directed to a modular system for providing information to traffic ways, such as roadways, runways and walkways. The system includes one or more lamp modules optionally provided in a message array, which may be embedded into the traffic way. The message array is controlled by signals generated by a control unit. Sensors, which may be remote from and/or positioned on or in the lamp modules, may be provided to sense various environmental conditions and convey a corresponding signal to the control unit. The sensed conditions signal may be used by the control unit to generate predetermined control signals in response to the sensed condition to be conveyed to the lamp modules.

### BACKGROUND OF THE INVENTION

Conventionally, in order to convey information, for example, to a traveller, vehicle driver or an airplane pilot regarding an area, such as a walkway, highway, roadway, runway or intersections thereof, (herein, collectively, “traffic ways”) a light or sign is used. The pavement forming the traffic way may be painted in an attempt to catch the attention of the traveller, driver or pilot and convey a number of types of desired information regarding the area. Some examples of the information may include speed limits, safety instructions, directional guidance, lane markings, traffic conditions, weather conditions and other typical traffic way information.

Alternatively, illuminated signs may be set alongside or overhead a roadway, pathway, taxiway or runway. Such conventional information tools are limited in that they may be obscured by heavy rain, fog, ice, or snow or other impediments. During periods of darkness, these signs must be illuminated by dedicated lights, or designed so as to be illuminated by the lights of the vehicle in order to be seen. In addition, in a condition of heavy traffic, signs may be partially or completely obscured by other traffic. Given that only some or none of the intended information is actually received by the traveller or pilot, dangerous situations become even more dangerous. Vehicles and planes may turn onto the wrong traffic way, or may make rapid changes in direction as the traveller realises an error, causing a potentially dangerous situation to develop.

Illuminated sign technology is well known. However, all such active signs must be set off to the side or well above vehicles in order to avoid being hit, destroyed, or driven over by vehicles.

A demand therefore is present for a system and method for easily providing information to a traveler on a travel way. The present invention satisfies the demand.

### SUMMARY OF THE INVENTION

The present invention includes a system whereby information can be transmitted in the form of emitted information by encapsulated lamp modules that can be placed in situations hostile to conventional signage and the like.

One embodiment of the lamp modules useful in the present system includes lamp modules using light emitting diodes (LEDs) to emit light in a pattern to convey the information. An example of such a module is described in U.S. patent application Ser. No. 10/089,823, filed Apr. 3, 2002, incorporated herein by reference. These modules may be placed in the pavement of a traffic way to provide various types of emitted information to a traveller.

The system includes one or more electronic lamp modules, which are capable of emitting visible or invisible light, infrared, radio, microwave and/or other portions of the electromagnetic spectrum, which shall herein be known as “emitted light” which is the basis of the transmitted emitted information. The emitted light is generated and emitted, “thrown”, transmitted, or broadcast in an organized fashion in order that the transmitted information such as directional information and guidance information may be conveyed to improve safety and guidance in, for example, a transportation setting, e.g., a roadway or the like.

The system may include sensors by which sensed information related to environmental or traffic conditions and the like may be received. The sensor may be a conventional sensor physically associated with the lamp modules or remotely connected to the control unit.

A control unit is provided to analyse the signals from the sensors (sensed information) and generate an appropriate control signal in order to effect actuation of the lamp modules to thus emit the transmitted information. The system can thus be interactively changed by the feedback provided by the sensed information to provide appropriate control signals to the lamp modules. This control unit may be part of the emitting lamp, lamp module or may be separate therefrom.

The emitted light may be in the form of visible light or other forms of the electromagnetic spectrum such as infra red (IR), Ultra Violet (UV), radio, microwave or other wavelengths. The emitting lamp devises such as light emitting diodes (LEDs), or other electronic devises (such as the sensors) are normally embedded into a solid, transparent, semi-opaque, mixed transparent and opaque, or completely opaque housing preferably using an injection moulding, casting or extrusion technique. The lamp and sensors could also be encased in a hollow weather resistant or waterproof housing or enclosure, designed to survive the harsh environment of roads or airfields, where vehicles will drive on them.

One embodiment of the present invention is a system by which light and/or other portions of the electromagnetic spectrum may be produced and “thrown, transmitted or broadcast” or “received”—these processes collectively termed “emitted” for purposes of this application—in an organized fashion such that information such as directional information and guidance information may be conveyed to or received from users of the travel way in order to improve safety and provide other benefits. The system of the present invention includes lamp modules organized into message arrays that are able to emit light in an organized fashion in order to convey important guidance and directional information even in conditions when conventional systems are unable to do so. Such emitted information may be visual, or the system may include emitted coherent or other emitted light to receivers on vehicles, remotely located information gathering systems, to onboard computers or cell phones so as to impart a guidance or safety message.

These message arrays are formed when lamp modules are combined into a coherent pattern. The message arrays may be laid into or onto the concrete, asphalt or other materials forming the surface of the travel way or pavement structure where pedestrians walk or airplanes, cars, trucks, bicycles and other vehicles drive. This way the message array is positioned in the direct pathway of the traffic, and will be highly visible as a result of its position with respect to the driver or pilot regardless of the current weather condition. The message array is positioned in an optimal viewing position where the driver or pilot has all their attention focused.

The system is sufficiently flexible such that it may be installed in a variety of environments such as airports, neighbourhoods, highways and streets, docks, ships, and other places that include travel ways and surfaces—such as pavement, walkways, ramps, airport apron, landing areas, or runways that are lighted or marked so as to convey information in order to provide direction or guidance. The system of the present invention is further formed by a sufficiently robust construction that the system may be installed in or adjacent to the travel way surface and can withstand severe environmental changes and the weight of vehicles or people traveling on or over them.

One embodiment of the message array allows the individual lamp modules to be organised in a way that will convey alphanumeric messages when individual or multiple lamp modules are energised. In this embodiment, the message array can relay written text or instruction as if it were a variable message array, but set in front of the pilot or driver.

A further embodiment of the present invention would include various sensors such as fog, or ice or other environmental sensors positioned within or operatively associated with the system that would trigger specific predetermined messages to be displayed by way of the message array.

One embodiment of the message array would allow the emitted light (forming a transmitted message) to change colour on command, and/or to pulse or flash in a multitude of different patterns to convey meaning or urgency to the message, and to provide an additional eye-catching feature to the message array layout out in front of the pilot or driver. Another embodiment of the message array could also be an animated or sequenced symbol, or a series of symbols such as arrows within the message array. A further embodiment could be animated or sequenced symbol, or a series of symbols such as discrete arrows within the pavement to indicate direction.

An embodiment of the lamp modules includes internal reflective or screening elements by which the direction of the emitted light can be directed, suppressed or controlled. The resulting directional lamp module may include devices that produce light or other portions of the electromagnetic spectrum.

The lamp module may include point source lights, laser diodes, incandescent bulbs, electroluminescent strips, or sensor/detector systems using microwave or other emitted parts of the electromagnetic spectrum and/or other sensors and/or lamp modules. It is preferred that the light emitting elements of the module are light emitting diodes (LEDs), since an LED provides a relative large amount of light for a comparatively small amount of power. The lamp modules are preferably provided in the form of a linear extrusion or injection moulded modular unit, including a plurality of encapsulated LEDs on an elongated support. The following will discuss the lamp module in terms of a module with one or more encapsulated supported LED even though other types of light-generating devices may be substituted.

The control unit includes electronic controls and other known devices needed for the operation and control of the lamp modules. Such devices and controls may include optical controls, dimming controls, connectors and connector control devices, radio frequency controls, voltage and current limiting or boosting controls, smart chip or addressable chips, antennas, interactive wireless, radio, and other communication devices. The control unit is connected either by standard wires or a wireless network to the lamp modules and to the sensors. In another embodiment, the control unit may be part of the lamp module. The wireless connection of the control unit to lamps and sensors may be made by way of a transmitter/receiver as is known in the art. In addition, the transmitter/receiver may be connected to other systems such as, a Department of Transportation, a cellular control center, a roadside control unit and other information control centers for the purpose of providing information from the sensors for controlling traffic or alerting officials of traffic conditions, for example.

The system includes elements that provide directionality to the light being produced by the lamp modules through reflection, refraction, the use of lenses, magnetic distortion or a combination of those techniques, or simple opaque parts to block, screen or prevent the emitted signal light from exiting in a direction that is not required. In such a manner the light from each lamp may be focused or directed in one or more desirable directions. The system includes aspects for sealing each module by encapsulation, for example to ensure the system is explosion proof and to seal the electrical components from the elements. Being explosion proof, the environment is similarly protected from the lamp modules.

The lamp modules may include isolated or grouped point source lights or lamp modules. It is preferred that the lights of the lamp modules include light emitting diodes (“LEDs”) since an LED provides a relative large amount of light for a comparatively small amount of power. The lamp modules are preferably in the form of a linear extrusion or injection moulding including a plurality of encapsulated LEDs on an elongated support.

The following will discuss the lamp modules in terms of a lamp module with encapsulated supported LEDs even though other light-generating elements may be substituted.

The pattern formed by the organization of at least the isolated or grouped lights or lamp modules convey the transmitted information. One or more lamp module may be arranged in specific patterns that use the specific properties of the “linear” light form provided by the module. For example, when all modules are aligned in one direction, the implied message is “follow this directon” (particularly important in guidance during bad weather). A light “chase” (sequential lighting of the LEDs in subsequent lamp modules) could enhance this type of message. When a series of lamp modules are set in a parallel orientation, a wide lit “band of light” is created. This lit wide band pattern makes use of the increased visibility of an “area of light”, which is much more visible than a single “line of light”, to form wide high visibility instructional signage such as Stop Line/bar positions at airport and road intersections. The specific details, such as spacing of the individual elements, may vary depending on the use and the required viewer visibility.

Embodiments of the present invention may include elongated LED lamp modules that emit light in a selected direction in order to convey information to the user, or infra red, ultra violet, microwave, radio frequency, or other parts of the electromagnetic spectrum which may flash or be sequenced or emit to communicate with receivers to impart information. The selected direction may be completely directional, semi-directional or omni directional depending on the requirements. Most viewers can see semi-directional light, but the brightest and most intense light can only be seen if the viewer or viewers are looking or receiving the information directly. Omni directional light is seen and read by all passing that point. A completely directional lamp module emits light such that the light emitted may be seen only by the intended viewer. For complete directonality, only the driver of the plane or vehicle facing the direction of emission can see the light. From all other directions the light is essentially not visible. In another embodiment, individual lamp modules emit light of a different color depending of the viewing orientation of a viewer, such as green one way and red all other ways or with control the opposite at other times. Such directional lighting is advantageous, for example with reference to a plane and its pilot, since the pilot can clearly see in what direction the plane should be directed and traveling. Distractions or light from other markings or lights on the runway or taxiway are avoided. Other planes taxiing or waiting on adjacent taxiways would not see the signal or light. The modules as a result may provide to taxiing pilots or drivers information regarding the direction of proper traffic flow on a runway or road, in which red is emitted for those vehicles traveling in the wrong direction, but green for those traveling in the correct direction. Similarly, the modules may be organized in a pattern to symbolize different surface conditions. For example, a road bridge may have amber lighting guidance elements that include sensors that determine whether the surface may be sufficiently cold to permit moisture to condense and form a frozen and thereby dangerous surface. The sensor would automatically change the color emission of the lamps in the module to blue or other readily understandable condition, which may or may not be animated in some fashion.

Other sensors incorporated within or external to the system may be similarly controlled, to provide the parts of the detector system able to communicate back to a central area or to other communication devices on detecting vehicles, people, or items marked with a smart chip or the like. Forward looking infra red, radar, microwave, and other area and proximity devices, metal detectors and other more limited devices able to detect specific stimuli such as magnetic properties or some disturbance with some ground generated tagged electromagnetic signal and these may be coordinated with the system to encompass and secure large areas and report back any and all detected sensor anomalies.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF THE DRAWINGS

The present invention is illustrated by the embodiments shown in the drawings, in which:

FIG. 1 is a cross-sectional view of one embodiment of the present invention taken transverse to a longitudinal axis of a lamp module;

FIG. 2 is a top view of another embodiment of a lamp module;

FIG. 3 is a cross-sectional view of the lamp module of FIG. 2 taken across line 3-3;

FIG. 4 is a cross-sectional view of the lamp module of FIG. 2 taken across line 4-4;

FIG. 5 is a top view of a plurality of lamp modules arranged into a message array at a taxiway/runway intersection, or at a crosswalk according to a further embodiment of the present invention;

FIG. 6 is a top view of a plurality of lamp modules arranged into a message array at a taxiway/runway intersection, or at a crosswalk according to a further embodiment of the present invention;

FIG. 7 is a top view of a plurality of lamp modules arranged into a message array according to a further embodiment of the present invention;

FIG. 8 is a diagrammatic illustration of another embodiment of the present invention; and

FIG. 9 is a diagrammatic illustration of another embodiment of a system of the present invention.

### DETAILED DESCRIPTION OF THE INVENTION

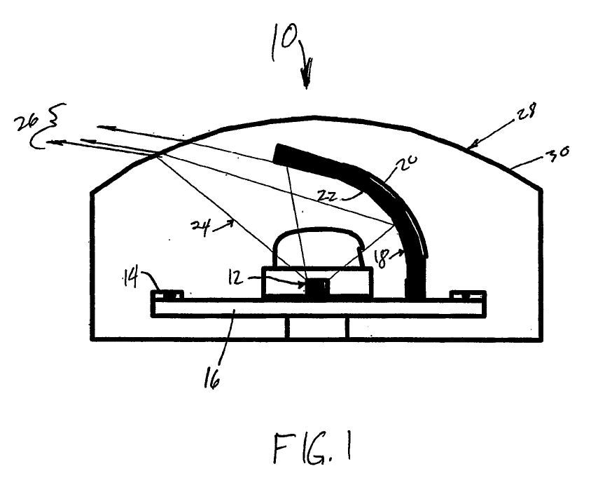

One embodiment of a lamp module is illustrated in FIG. 1, wherein the lamp module 10 includes one or more lamps 12, which are preferably LEDs (the cross section of only one of which is shown). The module 10 is made operational by known internal electronics and powered such as through BUSS wire 14 supported on an elongated support 16. The elongated support 16 may be formed of a material capable of acting as a heat sink to prevent the module 10 from overheating. Alternatively or additionally, the support 16 may include light controlling elements such as a reflective element 18. The reflective element 18 may function as a reflector or include an energy providing or collection devices 20 such as solar panels, batteries or photo-reflective items such as photo-luminescent panels, glass beads, prisms or laser etched and/or other plastic or metal reflective material. The reflective element may be partially transparent to allow some parts of the light to pass through.

The lamp module 10 is shown as including a reflective element 18. The reflective element 18 may be formed from metallic, plastic, crystalline, ceramic, or other similar reflective material. The reflective element 18 preferably is formed from material or materials by which the reflective element 18 may also have thermal conductive properties so as to act as both a reflector and thereby a light director and also a heat sink. The reflective element 18 may act individually as a heat sink or if in thermal contact with or part of the LEDs 12, or other heat generating devices (not shown), or other light source (not shown) or the support 16, also as an additional heat sink for other lamps 12 or associated electronic components (not shown).

The reflective element 18 may be curved so as to extend up from the support 16 and partially around the lamp 12, yet spaced from the upper surface of the lamp. The reflective element 18 includes a mirrored surface 22 such that light 24 from the LEDs 12 or other portions of the electromagnetic spectrum generated by the lamp 10 is directed away in a focused path 26. The reflective element 18 may extend the full length of the module 10 so as to provide directionality to all of the lighting elements included in the module where there is a plurality of lamps present.

Alternatively, the reflective elements 18 may be associated with only some of the lamps 12 so that the module 10 may accommodate a number of objectives. The reflective element 18 may be rotatable so that the reflective element 18 may be rotated or oriented to provide one or more different directionalities to the light 24. The reflective element 18 may also be curved, etched, be concave or convex to provide different foci. It is understood that such devices for focussing or scattering the light in specific or all directions are at need available to be included with the module 12.

The lamp module 10 includes a protective system 28 including encapsulation housing 30. The encapsulation housing 30 may be formed from a variety of plastic, glass, or resin materials in which the elements of the other systems are embedded such that water or moisture or flammable gases does not contact these other elements and such that the lamp module 10 is strengthened to lessen the likelihood that the lamps 12 and other aspects of the module 10 may be broken even when weight is placed on the module 10. The plastic encapsulation housing 30 may be clear, tinted or substantially opaque, so that the module 10 may be made less conspicuous or more conspicuous as desired and/or to lessen damage from ultraviolet rays.

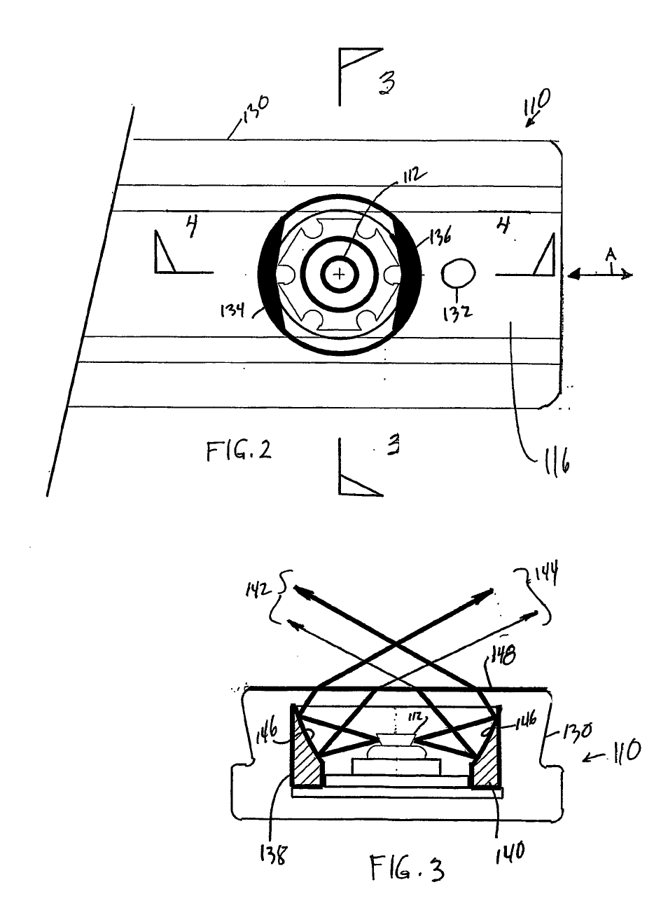

FIG. 2 shows another embodiment of a lamp module 110 of the present invention. The lamp module 110 includes a lamp 112 mounted to a elongated support 116, which may serve as both a base and heat sink for the lamp 112 and any needed electronics or other devices (not shown).

The housing 130 extends longitudinally along axis A to provide an elongate module 110 capable of housing a plurality of lamps 112 and other optional devices such as sensors 132. Left and right screen elements 134, 136 are arranged to the left and right of lamp 112 along axis A to prevent light from lamp 112 from exiting the module in the left and right directions (as illustrated in FIG. 2).

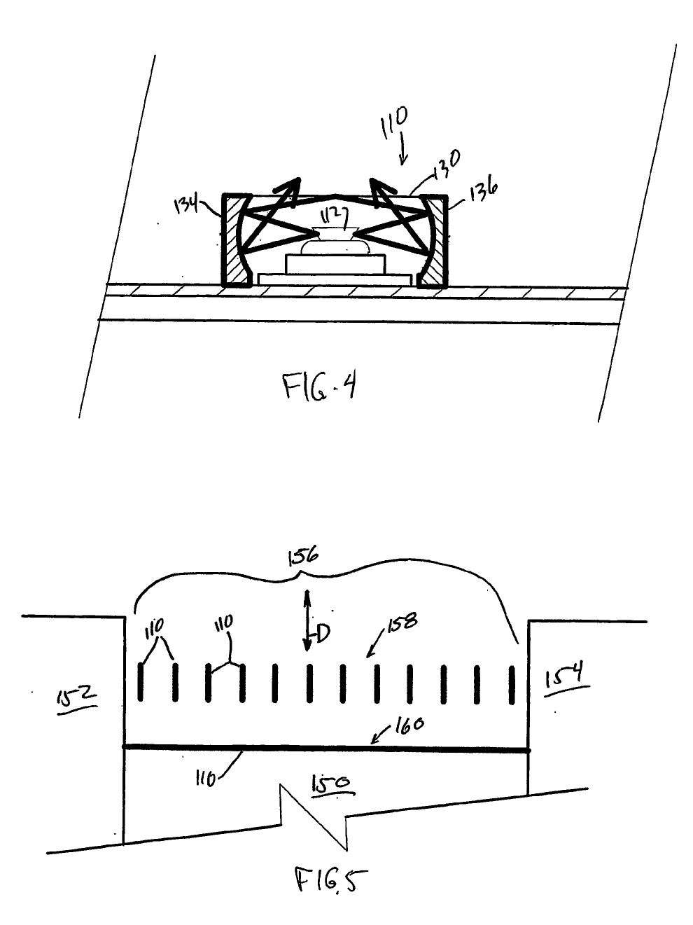

FIGS. 3 and 4 show the module 110 of FIG. 2 in cross-section along lines 3-3 and 4-4, respectively. Lamp 112 emits light through housing 130. First and second reflectors 138, 140 direct light from the lamp 112 in directions 142, 144 from module 110. Light directions 142, 144 are transverse to the axis A shown in FIG. 2. If the module 110 axis A is arranged transverse to the direction of travel on a roadway, the light direction 142, 144 is toward and away from the driver, respectively. In an alternate embodiment the module 110 may be arranged longitudinally with axis A oriented parallel to the direction of travel. In such a case, the light emitted from the module 110 will be emitted from the module in a left/right direction as opposed to a front/back direction. In a further embodiment, the screen elements 134, 136 and reflectors 138, 140 may be rotated 90 degrees to provide a corresponding change in direction of the light emission with respect to axis A. It is clear that other degrees of rotation can be used as needed.

It can be seen in FIG. 3 that the inner surface 146 of each of the first and second reflectors 138, 140 is angled upwardly, reflecting the light emitted from the lamp 112 and out of the top 144 of the housing 130 so as to be viewable. Conversely, screen elements 134, 136 can either absorb all of the light from lamp 112 or reflect the light upwardly and prevent the light from exiting along the sides of the lamp 112 along axis A (FIG. 2).

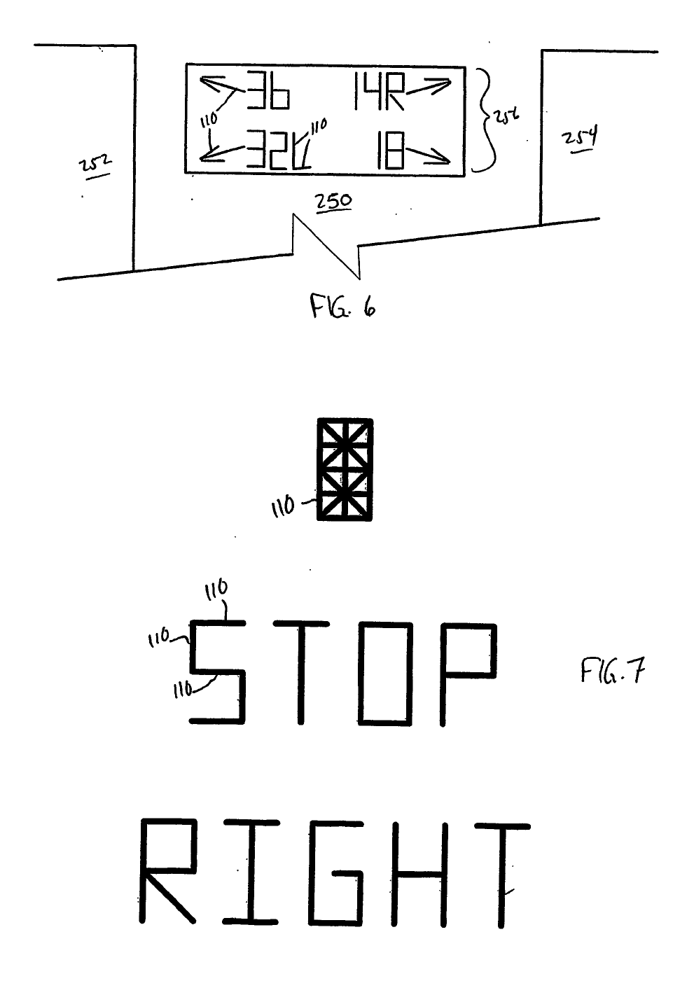

FIG. 5 shows a portion of a typical intersection 150 of a travel way (taxiway/runway). An embodiment of a message array 156 is illustrated extending between a first curb 152 and a second curb 154. The array 156 includes a plurality of organized modules 110. A first set of modules 110 are arranged in a side-by-side arrangement parallel to the direction of travel D at area 158 of the array 156. The first set 158 include reflectors such that light is emitted in a direction transverse to the axis A (FIG. 2). As a result, a wide band of light is created at the area 158 corresponding to a high visibility wide stop bar, e.g., or a crosswalk. A second set of modules 110 are arranged in an end-to-end arrangement transverse to the direction of travel D at area 160 of the array 156. As a result, a narrow band of light is created, a portion of which is emitted towards a driver approaching the intersection 150. The light emitted at area 160 would correspond to a stop line for vehicles.

FIG. 6 shows a portion of a typical intersection 250 of a pair of roadways. Another embodiment of a message array 256 is illustrated extending between a first curb 252 and a second curb 254. The array 256 includes a plurality of organized modules 110. It can be seen that the modules 110 can be organized to present numerical and graphical information.

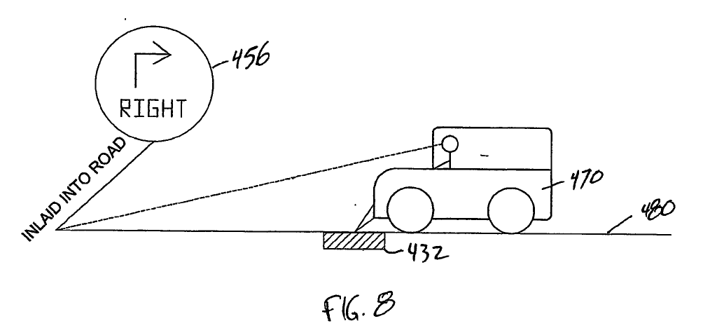

FIG. 7 shows another embodiment of a message array 356, which may be positioned in or along a travel way. It can be seen that the modules 110 can be organized to present textual information as well as symbols, numeric and graphical information.

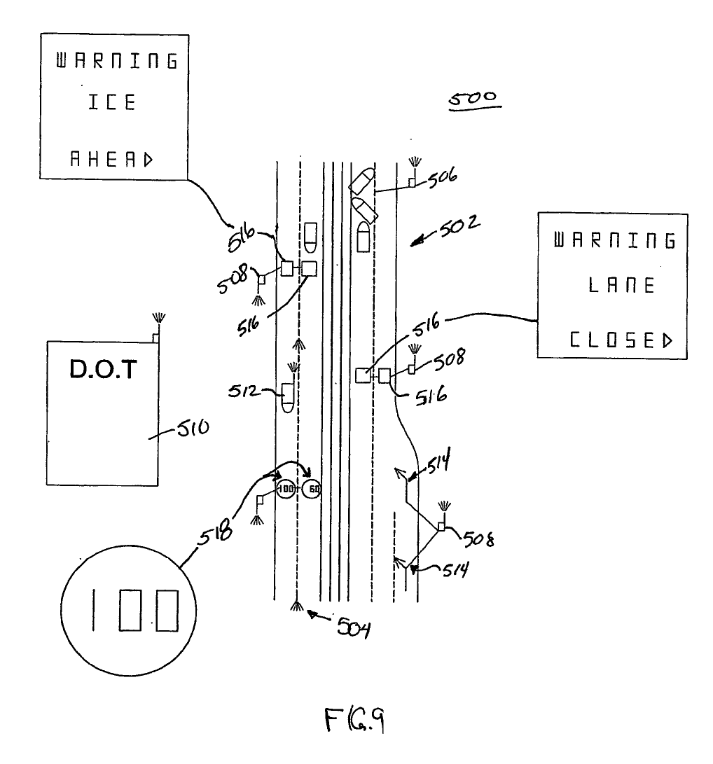

FIG. 8 illustrates a message array 456 containing both textual and graphical information inlaid into a travel way 480. In one embodiment, the array 456 is activated when a vehicle 470, travelling along the travel way 480 activates a module containing a sensor 432. In this manner, the array 456 only consumes energy when needed to provide information to the user of the vehicle 470. Alternatively, emitters and receivers in module may communicate interactively with each other to impart information. Alternatively, sensors in module 470 may record that the vehicle is stationary and may be involved in an accident, or broken down. The module would report such an event, and may trigger warning signals further back along the travel way. It will be understood that modules of the array 456 may include sensors and transmitters such as that of 432, which may communicate messages to the vehicle 470 through a number of devices, such as cell phones, radio and other electronic devices. The communication may cause lights ahead of the vehicle or modules ahead of the vehicle to appear or change according to the sensed condition. A stopped vehicle may cause a predetermined message to be communicated to a remote unit and produce a predetermined effect.

FIG. 9 illustrates one embodiment of an integrated information system 500 using a number of various message arrays according to the present invention. The system 500 is applied in this example along a multi-lane travel way 502. The system 500 includes one or more sensor, such as for example an environmental sensor 504. The environmental sensor 504 may be a conventional sensor capable of sensing temperature, fog, ice, rain light conditions or any useful environmental condition. The environmental sensor 504 may be positioned in or along or adjacent to the travel way 502. The environmental sensor 504 may convey an environmental signal communicating sensed environmental conditions by wire or wireless transmission to a control unit 508, a remote management facility 510, such as the Department of Transportation or directly to a vehicle receiver/transmitter 512, by wireless connection, for example.

A road sensor 506, which may sense traffic density or other traffic conditions may be positioned in or along the roadway 502 and may convey a road signal communicating sensed road conditions by wire or wireless transmission to a control unit 508, a remote management facility 510, such as the Department of Transportation or directly to a vehicle receiver 512, by wireless connection, for example. Other sensors are contemplated by the invention.

The control unit 508 is any suitable electronic unit capable of receiving transmissions from the various sensors 504, 506 and determining an appropriate action. The action may be to contact the remote management facility 510 with a predetermined message or to activate a message array, examples of which are shown at 514, 516 and variable speed limit signals 518. Message array 514 may be a fixed array, in that only merge information is displayed to alert drivers that lanes are being merged. Message array 516 displays variable textual information; in this example, related to a warning of changing traffic or environmental conditions. Message array 518 displays variable numeric information; in this example, related to changing speed limits. The message arrays 514, 516 and 518 may communicate with control units 508 by conventional wire or wireless connections, local or wide area networks or the like, and may be made responsive to changing signals from the control units 508 to provide variable alpha-numeric and graphical information thereby.

The control unit 508 may include a light control system (not shown) to control the arrays 514, 516, 518 and thereby the lamp modules 10 (FIG. 1). In an embodiment of the present invention the light control system may include a microprocessor or a programmable relay system, dimming system, photocell control or other such control devices so that the lamp modules 10 may be sequenced, flashed, alternately turned on and off or controlled so as to produce a colored or un-colored pattern. For example, around the array 514, a boundary can be formed in a color different from that of the graphic shown or controlled such that, for example, the boundary flashes in sequence or in tandem.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

1. A method of conveying information to a traveller comprising:
detecting a condition on a travel way;
generating a sensor signal based on the detected condition;
conveying the sensor signal to a control unit;
generating a control signal based on the sensor signal; and
conveying the control signal to one or more lamp modules imbedded within the travel way, wherein the lamp modules emit a predetermined light emission based on the control signal.

2. A modular information system for a traffic way comprising;
one or more sensor, said one or more sensor adapted to detect conditions along the traffic way and convey a condition signal based on said detected conditions;
one or more lamp modules imbedded within the traffic way, each said lamp module including a housing, a lamp for emitting light disposed within said housing and a directional member for providing directionality to the emitted light; and
an electronic control unit in communication with said one or more sensor and said one or more lamp modules for receiving said condition signal, generating a control signal based on the condition signal and transmitting said control signal to one or more of said one or more lamp modules.

3. A lamp module comprising:
a housing embeddable within a traffic way;
one or more lamp member disposed within said housing for emitting light; and
one or more directional member disposed within said housing positioned so as to direct the emitted light from said one or more lamp member.
